(19) United States
(12) Patent Application Publication
(10) Pub. No.: US 2011/0136437 A1
(43) Pub. Date: Jun. 9, 2011

(54) METHOD, DEVICE, AND SYSTEM FOR DISPLAYING CAPACITY OF BLUETOOTH DEVICE ON MOBILE TERMINAL

(76) Inventor: Shibao Zhao, Shenzhen (CN)

(21) Appl. No.: 13/030,951

(22) Filed: Feb. 18, 2011

Related U.S. Application Data
(63) Continuation of application No. PCT/CN2009/072691, filed on Jul. 8, 2009.

(30) Foreign Application Priority Data
Aug. 19, 2008 (CN) 200810141931.8

(51) Int. Cl. H04B 7/00; H04W 88/02

(52) U.S. Cl. 455/41.2

(57) ABSTRACT

A method, device, and system for displaying a capacity of a Bluetooth device on a mobile terminal with a Bluetooth function are provided. The method includes: receiving, by the mobile terminal, a residual capacity value from a Bluetooth device, in which the residual capacity value is configured to indicate a residual capacity of the Bluetooth device; and displaying the residual capacity of the Bluetooth device on a screen of the mobile terminal. The method enables a user of the mobile terminal with the Bluetooth function to know a capacity condition of the Bluetooth device in real time, and replace or charge the battery in time when the capacity of the Bluetooth device is low, thereby preventing the user experience from being affected or preventing a great loss from occurring.

### CROSS-REFERENCE TO RELATED APPLICATIONS

This application is a continuation of International Application No. PCT/CN2009/072691, filed on Jul. 8, 2009, which claims priority to Chinese Patent Application No. 200810141931.8, filed on Aug. 19, 2008, both of which are hereby incorporated by reference in their entireties.

### FIELD OF THE TECHNOLOGY

The present invention relates to the Bluetooth technology, and more particularly to a method, device, and system for displaying a capacity of a Bluetooth device on a mobile terminal with a Bluetooth function.

### BACKGROUND OF THE INVENTION

Bluetooth technology, as a short-distance wireless communication technology, enables two parties to communicate with each other based on Bluetooth signals having a small coverage area. With the advantages of low power consumption, low cost, a small product volume, and high applicability, the Bluetooth technology has been widely used in daily communications. Hence, the Bluetooth function becomes a function contained in standard configuration of current mobile terminals (such as mobile phones) and is disposed in the mobile terminals.

Correspondingly, a mobile terminal with a Bluetooth function such as a Bluetooth mobile phone is usually connected to a device such as a Bluetooth headset, so as to facilitate the use. However, limited by the volume of the Bluetooth headset, the battery power of the Bluetooth headset cannot last long, that is to say, the Bluetooth headset often powers off due to lack of power. For example, the headset suddenly powers off due to lack of power when the user is having a phone call using the Bluetooth headset, which may affect the user experience or cause a loss to the user.

In the implementation of the present invention, the inventor found that the prior art at least has the following problems.

The use of the Bluetooth device connected to the Bluetooth mobile phone is restricted by the volume of the Bluetooth device, and the user often cannot know a capacity condition of the Bluetooth device, so that the battery of the Bluetooth device cannot be replaced in time, which may affect the user experience or cause a loss to the user.

### SUMMARY OF THE INVENTION

Accordingly, the present invention is directed to a method, device, and system for displaying a capacity of a Bluetooth device on a mobile terminal with a Bluetooth function, so as to enable a user of the mobile terminal with the Bluetooth function to know a capacity condition of the Bluetooth device in real time, and replace or charge the battery in time when the capacity of the Bluetooth device is low, thereby preventing the user experience from being affected or preventing a possible loss from occurring.

In order to solve the foregoing technical problems, in one aspect, the present invention provides a method for displaying a capacity of a Bluetooth device on a mobile terminal with a Bluetooth function. The Bluetooth device is connected to the mobile terminal over Bluetooth. The method includes:

receiving, by the mobile terminal, a residual capacity value from a Bluetooth device, in which the residual capacity value is configured to indicate a residual capacity of the Bluetooth device; and

displaying the residual capacity of the Bluetooth device on a screen of the mobile terminal.

In order to solve the foregoing technical problems, in another aspect, the present invention further provides a mobile terminal with a Bluetooth function, which includes:

a receiving module, configured to receive a residual capacity value from a Bluetooth device over Bluetooth, in which the residual capacity value is configured to indicate a residual capacity of the Bluetooth device; and

a display module, configured to display the residual capacity of the Bluetooth device on a screen of the mobile terminal.

In order to solve the foregoing technical problems, in still another aspect, the present invention further provides a Bluetooth system, which includes a Bluetooth device and a mobile terminal with a Bluetooth function, in which:

the Bluetooth device is configured to calculate a residual capacity thereof, and notify a residual capacity value indicating the residual capacity to the mobile terminal; and

the mobile terminal is connected to the Bluetooth device over Bluetooth, and is configured to display the residual capacity of the Bluetooth device on a screen.

It can be seen from the above technical solution that, the present invention enables the user of the mobile terminal with the Bluetooth function to know the capacity condition of the Bluetooth device in real time, and replace or charge the battery in time when the capacity of the Bluetooth device is low, thereby preventing the user experience from being affected or preventing a great loss from occurring.

### BRIEF DESCRIPTION OF THE DRAWINGS

To make the technical solution under the present invention clearer, the accompanying drawings for illustrating the embodiments of the present invention or the prior art are outlined below. Apparently, the accompanying drawings are for the exemplary purpose only, and person having ordinary skill in the art can derive other drawings from such accompanying drawings without any creative effort.

FIG. 1 is a flow chart of a method for displaying a capacity of a Bluetooth device on a Bluetooth mobile phone according to an embodiment of the present invention;

FIG. 2 is a block diagram of a Bluetooth mobile phone according to an embodiment of the present invention;

FIG. 3 is a block diagram of a Bluetooth system according to an embodiment of the present invention; and

FIG. 4 is a block diagram of another Bluetooth mobile phone according to another embodiment of the present invention.

### DETAILED DESCRIPTION OF THE EMBODIMENTS

The following detailed description is directed to the technical solution of the present invention with reference to the accompanying drawings. However, the embodiments to be described are only some embodiments of the present invention. Person having ordinary skill in the art can derive other embodiments from the embodiments given herein without making any creative effort, and all such embodiments are covered in the protection scope of the present invention.

The present invention provides a method, device, and system for displaying a capacity of a Bluetooth device on a Bluetooth mobile phone, so as to enable a user of the Bluetooth mobile phone to know a capacity condition of the Bluetooth device in real time, and replace or charge the battery in time when the capacity of the Bluetooth device is low, thereby preventing the user experience from being affected or preventing a great loss from occurring.

Firstly, it should be noted that, in the present invention, the Bluetooth device refers to a device that can be connected to the Bluetooth mobile phone through Bluetooth technology, such as a Bluetooth headset.

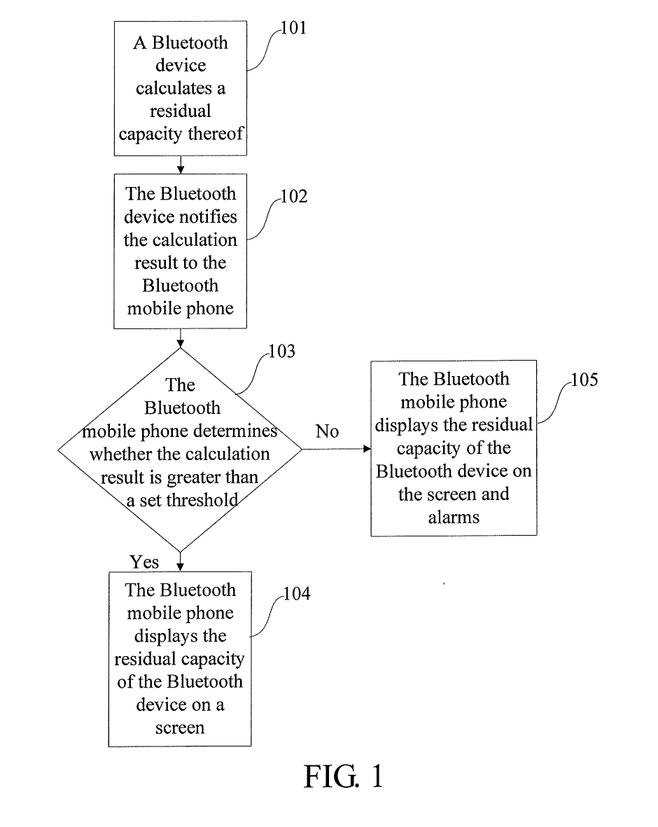

FIG. 1 is a flow chart of a method for displaying a capacity of a Bluetooth device on a Bluetooth mobile phone according to an embodiment of the present invention. Referring to FIG. 1, the method includes the following steps.

Step 101: A Bluetooth device calculates a residual capacity thereof.

Specifically, the Bluetooth device should periodically calculate the residual capacity thereof, and a calculation result is generally a percentage representing a proportion of the residual capacity in the total capacity, or time representing a time for which the residual capacity can be used by the Bluetooth device, or capacity representing a value of the residual capacity in the unit of coulombs. The periodic calculation is for the purpose of real-time display, and meanwhile, since the Bluetooth device consumes a certain amount of power during calculation, the period cannot be too short, and 5-10 mins is recommended. The periodic calculation of the Bluetooth device may generally be activated by two methods: one method is that the Bluetooth mobile phone periodically notifies, through a message, the Bluetooth device to calculate the residual capacity thereof; and the other method is that the Bluetooth device itself periodically calculates the residual capacity thereof.

In addition, in a general case, when the Bluetooth device is not connected to the Bluetooth mobile phone through Bluetooth technology, the Bluetooth device does not calculate the residual capacity thereof, thereby avoiding waste of the power thereof.

Step 102: The Bluetooth device notifies the calculation result to the Bluetooth mobile phone.

Specifically, each time the Bluetooth device calculates the residual capacity thereof, the Bluetooth device notifies the calculation result to the Bluetooth mobile phone connected thereto.

Step 103: The Bluetooth mobile phone determines whether the calculation result is greater than a set threshold.

Specifically, when receiving the calculation result (that is, the residual capacity of the Bluetooth device) notified by the Bluetooth device, the Bluetooth mobile phone compares the calculation result with the set threshold; if the calculation result is greater than the set threshold, Step 104 is performed; and if the calculation result is smaller than the set threshold, Step 105 is performed.

The set threshold is a criterion for determining whether the capacity of the Bluetooth device is low, and should in a form consistent with the form of the calculation result. For example, if the calculation result is expressed in percentage, the set threshold should be in the form of a percentage or decimal; and if the calculation result is time, the set threshold should be in the form of time.

Step 104: The Bluetooth mobile phone displays the residual capacity of the Bluetooth device on a screen.

Specifically, the residual capacity of the Bluetooth device may be displayed by using a battery capacity state identification or by using a battery capacity state identification and marking the calculation result inside or outside the battery capacity state identification.

For example, if the calculation result is recorded in the form of a percentage, when the calculation result is greater than or equal to 65%, the battery capacity state identification may be displayed as three bars (full); when the calculation result is greater than or equal to 33% and smaller than 65%, the battery capacity state identification may be displayed as two bars; and when the calculation result is smaller than 33%, the battery capacity state identification may be displayed as one bar. In other words, no matter whether the calculation result is 40%, 50% or 60%, the battery capacity state identification is displayed as two bars. It can be seen that, the battery capacity state identification can be used to display the residual capacity of the Bluetooth device approximately. At this time, if the calculation result, for example, 50%, is marked inside or outside the battery capacity state identification, the residual capacity of the Bluetooth device can be accurately displayed, such that a user can accurately know the capacity condition of the Bluetooth device. In addition, the battery capacity state identification may also be an identification that only identifies the calculation result on a status bar or other interfaces of the Bluetooth mobile phone.

Step 105: The Bluetooth mobile phone displays the residual capacity of the Bluetooth device on the screen, and at the same time the Bluetooth mobile phone alarms to remind the user.

Specifically, when the calculation result is smaller than the set threshold, indicating that the user needs to replace or charge the battery, not only the residual capacity of the Bluetooth device needs to be displayed on the screen of the mobile phone, but the user also needs to be reminded of the information, that is, an alarm needs to be given. The alarming may be performed by emitting an alert tone or popping up a window, such as “the capacity of your Bluetooth device is too low, please replace the battery” or “the capacity of your Bluetooth device is too low, please charge the battery”.

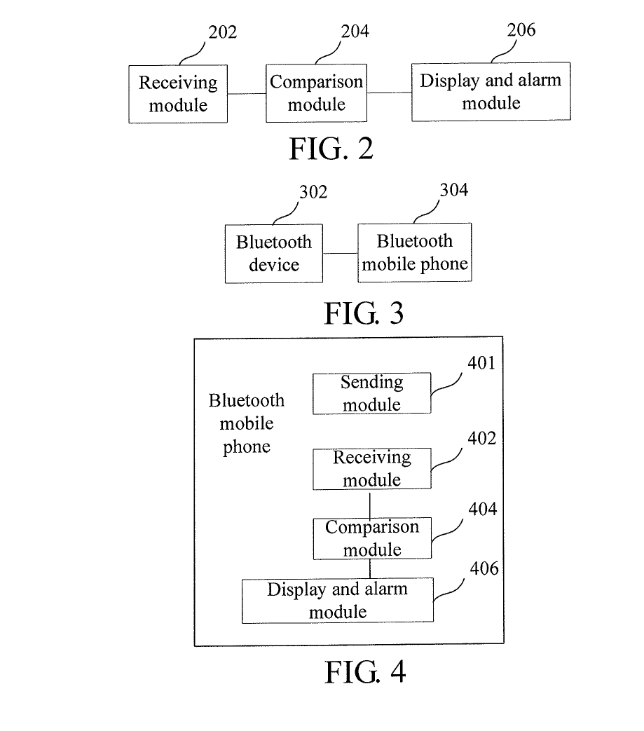

FIG. 2 is a block diagram of a Bluetooth mobile phone according to an embodiment of the present invention, which includes a receiving module 202, a comparison module 204, and a display and alarm module 206.

The receiving module 202 is configured to receive a calculation result from a Bluetooth device over Bluetooth, in which the calculation result represents a residual capacity of the Bluetooth device periodically calculated by the Bluetooth device.

The comparison module 204 is configured to compare the calculation result with a set threshold.

The display and alarm module 206 is configured to display the residual capacity of the Bluetooth device on a screen of the Bluetooth mobile phone if the calculation result is greater than the set threshold, and display the residual capacity of the Bluetooth device on the screen of the Bluetooth mobile phone and alarm if the calculation result is smaller than the set threshold.

FIG. 3 is a block diagram of a Bluetooth system according to an embodiment of the present invention, which includes a Bluetooth device and a Bluetooth mobile phone.

The Bluetooth device 302 is configured to calculate a residual capacity thereof, and notify a calculation result to the Bluetooth mobile phone 304.

The Bluetooth mobile phone 304 is connected to the Bluetooth device 302 over Bluetooth, and is configured to determine whether the calculation result is greater than a set threshold, display the residual capacity of the Bluetooth device 302 on a screen of the Bluetooth mobile phone 304 if the calculation result is greater than the set threshold, and display the residual capacity of the Bluetooth device 302 on the screen of the Bluetooth mobile phone 304 and alarm if the calculation result is smaller than the set threshold.

As for the specific implementation of the device and system for displaying a capacity of a Bluetooth device on a Bluetooth mobile phone provided in the embodiments of the present invention, reference is made to the method according to the embodiment of the present invention, and the details will not be described herein again.

FIG. 4 is a block diagram of a Bluetooth mobile phone according to another embodiment of the present invention, which includes a sending module 401, a receiving module 402, a comparison module 404, and a display and alarm module 406.

The sending module 401 is configured to send a request message for acquiring a residual capacity value to a Bluetooth device. The Bluetooth device may calculate a residual capacity thereof after receiving the request message sent by the sending module and send a calculation result to the Bluetooth mobile phone.

The receiving module 402 is configured to receive the calculation result from the Bluetooth device over Bluetooth, in which the calculation result represents the residual capacity of the Bluetooth device periodically calculated by the Bluetooth device.

The comparison module 404 is configured to compare the calculation result with a set threshold.

The display and alarm module 406 is configured to display the residual capacity of the Bluetooth device on a screen of the Bluetooth mobile phone if the calculation result is greater than the set threshold, and display the residual capacity of the Bluetooth device on the screen of the Bluetooth mobile phone and alarm if the calculation result is smaller than the set threshold.

Persons of ordinary skill in the art may understand that all or part of the steps of the method according to the embodiments of the present invention may be implemented by a program instructing relevant hardware. The program may be stored in a computer readable storage medium. The storage medium may be a magnetic disk, a Compact Disk Read-Only Memory (CD-ROM), a Read-Only Memory (ROM) or a Random Access Memory (RAM).

The above descriptions are merely preferred embodiments of the present invention, but not intended to limit the scope of the present invention. Any modification, equivalent replacement, or improvement made without departing from the spirit and principle of the present invention should fall within the scope of the present invention.

1. A method for displaying a capacity of a Bluetooth device on a mobile terminal with a Bluetooth function, wherein the Bluetooth device is connected to the mobile terminal over Bluetooth, the method comprising:
receiving, by the mobile terminal, a residual capacity value from a Bluetooth device, wherein the residual capacity value is configured to indicate a residual capacity of the Bluetooth device; and
displaying the residual capacity of the Bluetooth device on a screen of the mobile terminal.

2. The method according to claim 1, wherein before the receiving, by the mobile terminal, the residual capacity value from the Bluetooth device, the method further comprises:
sending a request message for acquiring the residual capacity value to the Bluetooth device.

3. The method according to claim 1, wherein the residual capacity value is a residual capacity value periodically calculated by the Bluetooth device.

4. The method according to claim 1, further comprising:
determining, by the mobile terminal, whether the residual capacity value is greater than a set threshold, and providing an alarm if the residual capacity value is smaller than the set threshold.

5. The method according to claim 1, wherein the residual capacity value is expressed in a percentage, time, or capacity.

6. The method according to claim 1, wherein the residual capacity of the Bluetooth device is displayed on the screen of the mobile terminal by using a battery capacity state identification.

7. The method according to claim 6, wherein the residual capacity of the Bluetooth device is displayed on the screen of the mobile terminal by marking the residual capacity value inside or outside the battery capacity state identification.

8. The method according to claim 4, wherein the alarming is performed by emitting an alert tone or popping up a window.

9. A mobile terminal with a Bluetooth function, comprising:
a receiving module, configured to receive a residual capacity value from a Bluetooth device over Bluetooth, wherein the residual capacity value is configured to indicate a residual capacity of the Bluetooth device; and
a display module, configured to display the residual capacity of the Bluetooth device on a screen of the mobile terminal.

10. The mobile terminal according to claim 9, further comprising:
a sending module, configured to send a request message for acquiring the residual capacity value to the Bluetooth device.

11. The mobile terminal according to claim 9, further comprising:
a comparison module, configured to compare the residual capacity value with a set threshold; and
an alarm module, configured to provide an alarm if the residual capacity value is smaller than the set threshold.

12. The mobile terminal according to claim 11, wherein
the alarm module alarms by emitting an alert tone or popping up a window on a device of the mobile terminal.

13. A Bluetooth system, comprising a Bluetooth device and a mobile terminal with a Bluetooth function, wherein
the Bluetooth device is configured to calculate a residual capacity thereof, and notify a residual capacity value indicating the residual capacity to the mobile terminal; and
the mobile terminal is connected to the Bluetooth device over Bluetooth, and is configured to display the residual capacity of the Bluetooth device on a screen.

14. The system according to claim 13, wherein
the mobile terminal is further configured to determine whether the residual capacity value is greater than a set threshold, and alarm if the residual capacity value is smaller than the set threshold.
